(19) United States
(12) Patent Application Publication
(10) Pub. No.: US 2016/0104117 A1
(43) Pub. Date: Apr. 14, 2016

(54) Employment Verification and Recruiting Platform and Method of Use

(71) Applicants: Thomas Pash, Houston, TX (US); Aleksandar Memca, Houston, TX (US)

(72) Inventors: Thomas Pash, Houston, TX (US); Aleksandar Memca, Houston, TX (US)

(73) Assignee: Skill Link LLC d/b/a FYnderFY, Houston, TX (US)

(21) Appl. No.: 14/880,188

(22) Filed: Oct. 9, 2015

Related U.S. Application Data
(60) Provisional application No. 62/061,730, filed on Oct. 9, 2014.

(51) Int. Cl. G06Q 10/10; G06F 17/30

(52) U.S. Cl. CPC G06Q 10/1053; G06F 17/30707

(57) ABSTRACT

An apparatus, comprising at least one memory including computer program code and at least one processor. The apparatus designed to: catalog users in a user list table as being an applicant, an educator, and/or a recruiter; correlate one or more open opportunities with a one or more credentials; correlate the one or more credentials with a one or more educational resource. The one or more educational resources each comprising a test. A portion of the users comprising applicants qualify under a portion of the one or more credentials and apply for a portion of the one or more open opportunities correlated with the one or more credentials. The portion of the users comprising the educators selectively create the one or more educational resource to support the credentialing process for the applicants and the recruiters.

### CROSS-REFERENCE TO RELATED APPLICATIONS

This patent application claims the benefit of 62/061730, filed on Nov. 9, 2014.

### STATEMENT REGARDING FEDERALLY SPONSORED RESEARCH OR DEVELOPMENT IF APPLICABLE

Not applicable.

### REFERENCE TO SEQUENCE LISTING, A TABLE, OR A COMPUTER PROGRAM LISTING COMPACT DISC APPENDIX IF APPLICABLE

Not applicable.

### BRIEF SUMMARY OF THE INVENTION

An apparatus, a method of use and a computer program are disclosed.

These disclosures comprising at least one memory including computer program code and at least one processor. The at least one memory and the computer program code are configured to, with the at least one processor, cause the apparatus at least to: catalog users in a user list table as being an applicant, an educator, and/or a recruiter; correlate one or more open opportunities with a one or more credentials; correlate the one or more credentials with a one or more educational resource. The one or more educational resources each comprising a test. A portion of the users comprising applicants qualify under a portion of the one or more credentials and apply for a portion of the one or more open opportunities correlated with the one or more credentials. The portion of the users comprising the educators selectively create the one or more educational resource to support the credentialing process for the applicants and the recruiters. The recruiters set up the one or more opportunities and select a portion of the one or more educational resources for the one or more opportunities.

### BACKGROUND OF THE INVENTION

This disclosure relates generally to an employment verification and recruiting platform and method of use. None of the known inventions and patents, taken either singularly or in combination, is seen to describe the instant disclosure as claimed. Accordingly, an improved employment verification and recruiting platform and method of use would be advantageous.

### BRIEF DESCRIPTION OF THE SEVERAL VIEWS OF THE DRAWING

FIG. 1 illustrates a first network configuration 101 of an employment platform 100.

FIGS. 2A, 2B and 2C illustrate a perspective overview of a mobile phone 201a, a personal computer 201b and a tablet 201c.

FIGS. 3A and 3B illustrate an address space 302 within said one or more computers, and an embodiment for collecting and storing data with said employment platform 100; a first embodiment with a flow diagram between said first computer 102a and said server 108, and a second embodiment comprising of just said first computer 102a.

FIGS. 4A and 4B illustrate two examples of a flow diagram between said memory 306a and said memory 306d.

FIG. 5 illustrates database relationship view of an application database 500.

FIG. 6 illustrates user relationship diagram of a user roles Venn diagram 600.

FIG. 7 illustrates diagram view of a database table relationship diagram 700.

FIG. 8 illustrates a user interface view of an employment platform data system 800.

FIG. 9 illustrates a user interface view of a user credentials tab 802b.

FIG. 10 illustrates a user interface view of an all available credentials tab 802c.

FIG. 11 illustrates a user interface view of a my applications tab 802d.

FIG. 12 illustrates a user interface view of a learning center tab 802e.

FIG. 13 illustrates a user interface view of a resource creation tab 802f.

FIG. 14 illustrates a database table view of said user list table 502.

FIG. 15 illustrates a database table view of said credential list table 504.

FIG. 16 illustrates a database table view of said CRT user credentials table 506.

FIG. 17 illustrates a database table view of said job listing table 508.

FIG. 18 illustrates a database table view of said education resource table 510.

FIG. 19 illustrates a database table view of said test list table 512.

FIG. 20 illustrates a database table view of said exam question bank table 514.

### DETAILED DESCRIPTION OF THE INVENTION

Described herein is an employment verification and recruiting platform and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation as in any development project, design decisions must be made to achieve the designers' specific goals e.g., compliance with system- and business-related constraints, and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

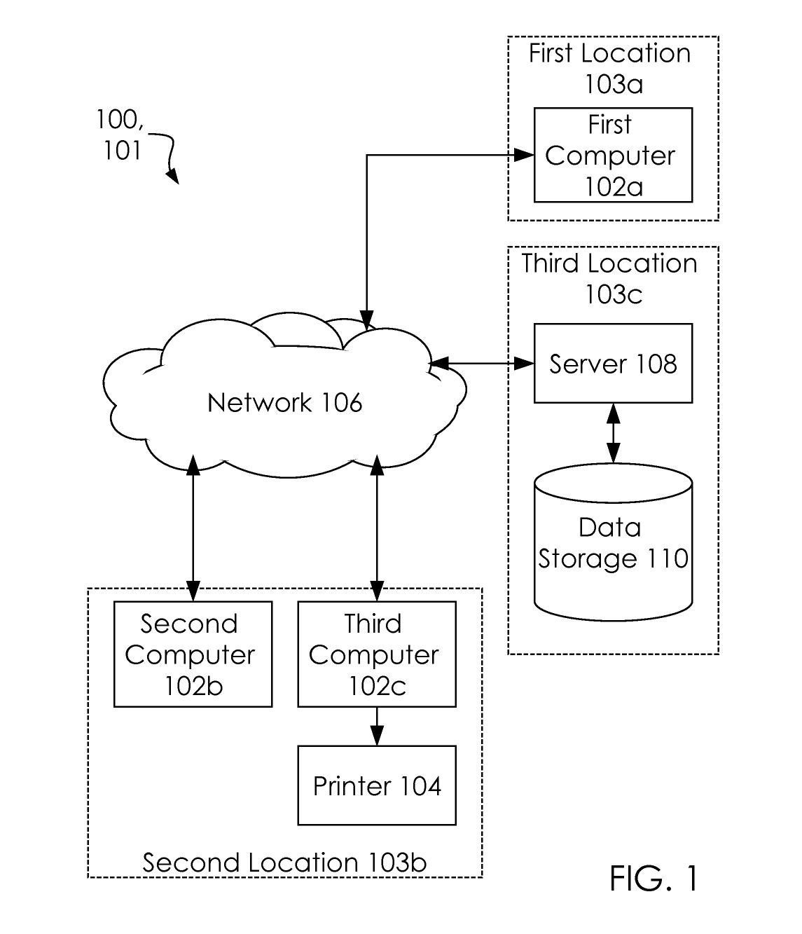

FIG. 1 illustrates a first network configuration 101 of an employment platform 100.

In one embodiment, said employment platform 100 can comprise a one or more computers at a one or more locations. In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers such as a server 108. In one embodiment, a printer 104 can be hardwired to said first computer 102a not illustrated here, or said printer 104 can connect to one of said one or more computers such as said third computer 102c, illustrated via network 106.

Said network 106 can be a local area network LAN, a wide area network WAN, a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed interconnected via any suitable communications network.

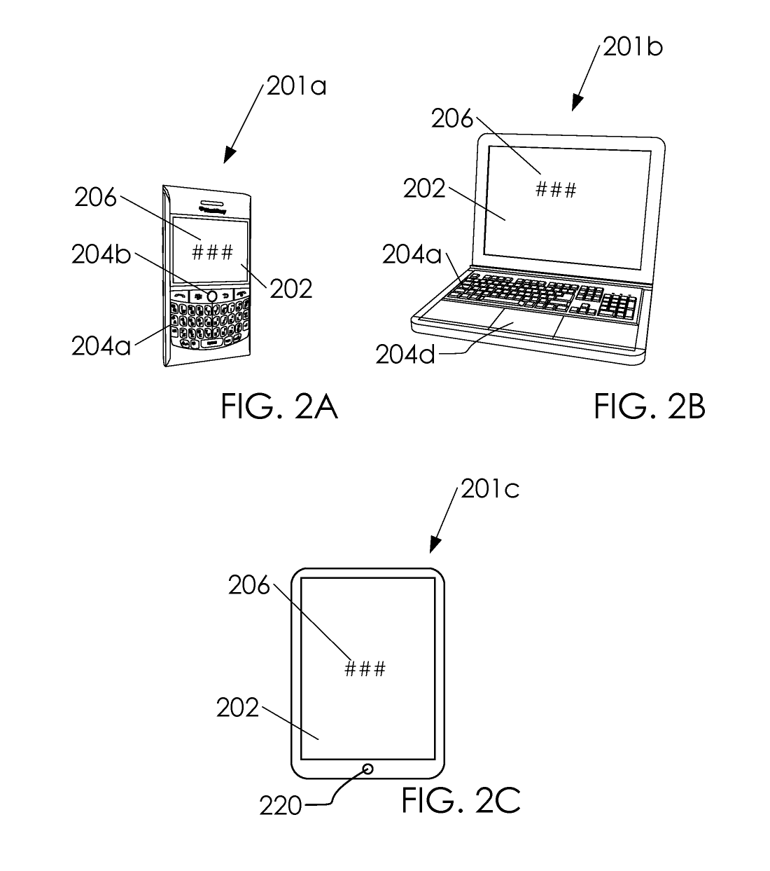

FIGS. 2A, 2B and 2C illustrate a perspective overview of a mobile phone 201a, a personal computer 201b and a tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop such as said personal computer 201b, desktop, workstation, server, mainframe, terminal, a tablet such as said tablet 201c, a phone such as said mobile phone 201a, and/or similar. Despite different form-factors, said one or more computers can have similar basic hardware, such as a screen 202 and an One or more input devices such as a keyboard 204a, a trackball 204b, an one or more cameras 204c, a wireless—such as RFID—reader, a track pad 204d, and/or a home button 220. In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said employment platform 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 where said screen 202 is a touch screen. Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

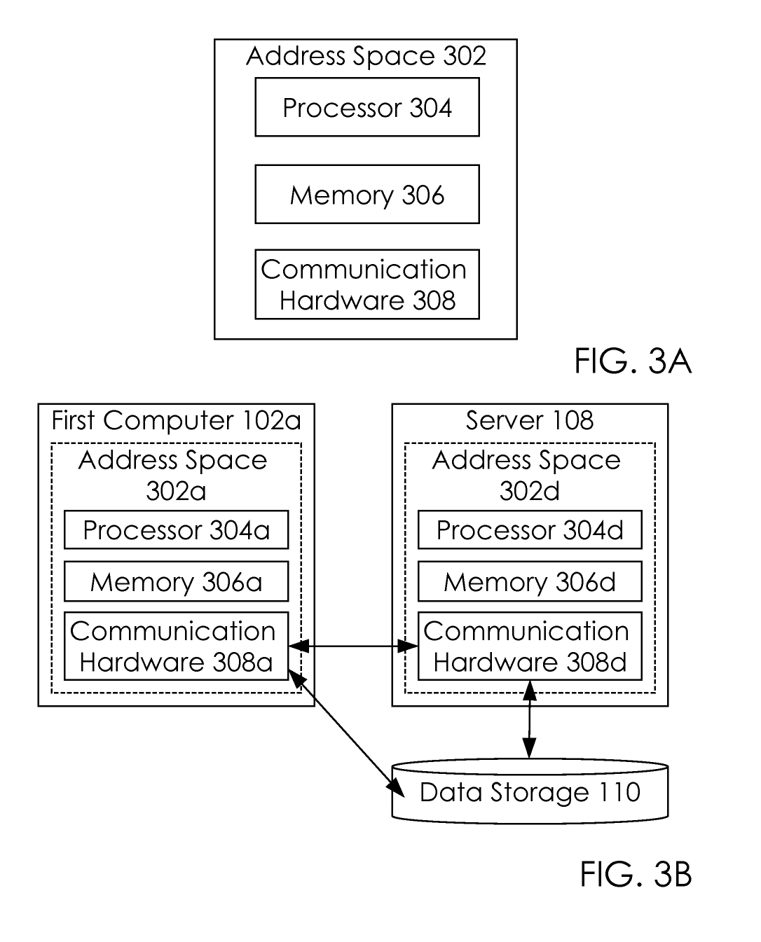

FIGS. 3A and 3B illustrate an address space 302 within said one or more computers, and an embodiment for collecting and storing data with said employment platform 100; a first embodiment with a flow diagram between said first computer 102a and said server 108, and a second embodiment comprising of just said first computer 102a.

Regarding FIG. 3A, each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to an One or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

Regarding FIG. 3B, in one embodiment, said first computer 102a can comprise an address space 302a, a processor 304a, a memory 306a, and a communication hardware 308a. Likewise, in one embodiment, said server 108 can comprise an address space 302d, a processor 304d, a memory 306d, and a communication hardware 308d. In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said employment platform 100. In another embodiment, said data can be stored temporarily on said data storage 110a and later moved to said data storage 110 for backup and sharing purposes.

In one embodiment, said server 108 can comprise a third party data storage and hosting provider or privately managed as well. In another embodiment, said data storage 110 can be located on said first computer 102a, not illustrated here. Thus, said first computer 102a can operate without a data connection out to said server 108 while performing said system and method for field capture of data.

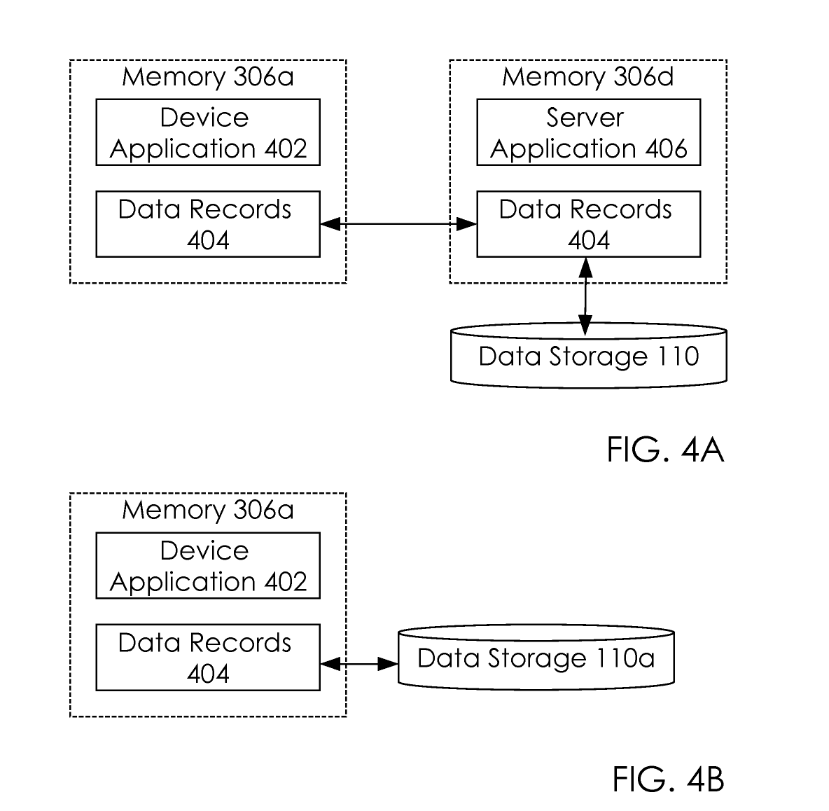

FIGS. 4A and 4B illustrate two examples of a flow diagram between said memory 306a and said memory 306d.

As illustrated in FIG. 4A, in one embodiment, said employment platform 100 can process said data 206 on said first computer 102a and/or said server 108. For example, in one embodiment, said memory 306a can comprise a device application 402 capable of generating a data records 404 from user inputs or, otherwise, processing said data records 404 delivered to said device application 402 from said data storage 110. In one embodiment, said data records 404 can be transferred between said device application 402 on said memory 306a of said first computer 102a and a server application 406 in said memory 306d of said server 108. In one embodiment, said server 108 can be useful for processing said data 206, as is known in the art. As illustrated in FIG. 4B, in another embodiment, said server 108 can be removed from the flow diagram entirely as said memory 306a is capable of processing said data records 404 and/or said data 206 without the assistance of said server 108.

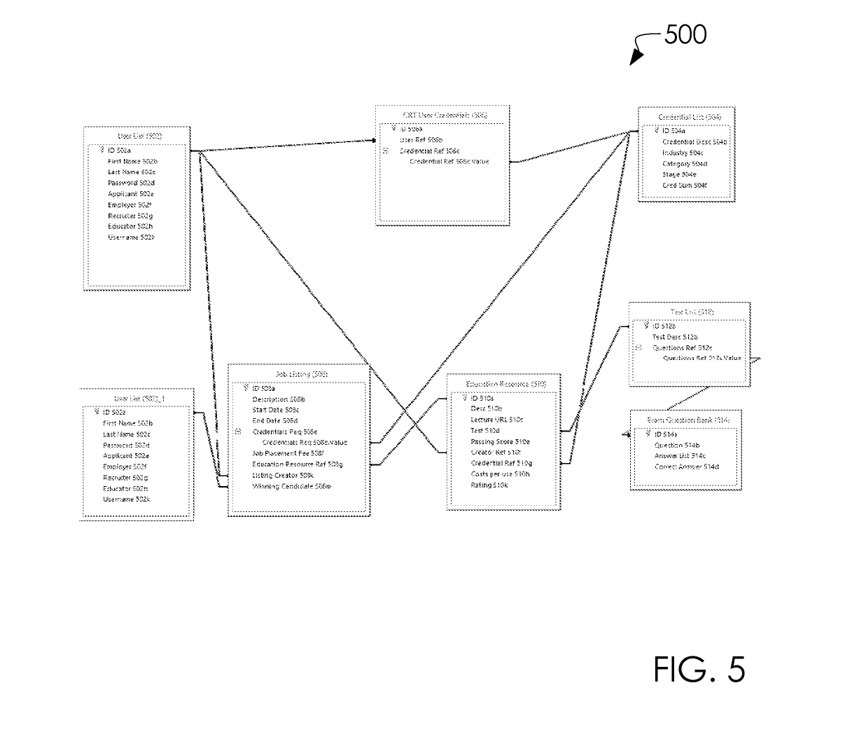

FIG. 5 illustrates database relationship view of an application database 500.

Illustrated herein are an application database 500, an user list table 502, an ID 502a, a First Name 502b, a Last Name 502c, a Password 502d, an Applicant 502e, an Employer 502f, a Recruiter 502g, an Educator 502h, an Username 502k, a credential list table 504, an ID 504a, a Credential Desc 504b, an Industry 504c, a Category 504d, a Stage 504e, a Cred Sum 504f, a CRT user credentials table 506, an ID 506a, an User Ref 506b, a Credential Ref 506c, a job listing table 508, an ID 508a, a Description 508b, a Start Date 508c, an End Date 508d, a Credentials Req 508e, a Job Placement Fee 508f, an Education Resource Ref 508g, a Listing Creator 508h, a Winning Candidate 508k, an education resource table 510, an ID 510a, a Desc 510b, a Lecture URL 510c, a Test 510d, a Passing Score 510e, a Creator Ref 510f, a Credential Ref 510g, a Costs per use 510h, a Rating 510k, a test list table 512, an ID 512a, a Test Desc 512b, a Questions Ref 512c, an exam question bank table 514, an ID 514a, a Question 514b, an Answer List 514c, a Correct Answer 514d.

In one embodiment, said application database 500 can comprise said user list table 502, said credential list table 504, said CRT user credentials table 506, said job listing table 508, said education resource table 510, said test list table 512, said exam question bank table 514.

In one embodiment, said application database 500 can illustrate the database relationships between a one or more tables within a database. In one embodiment, said application database 500 can comprise a relational database and can be exemplary of one manner in which said device application 402 can be enabled.

Said data relationship diagram 500 can comprise one embodiment of an arrangement of said plurality of tables and their relational aspects. It is noted that said data relationship diagram 500 is one embodiment of said employment platform 100 but not the only embodiment thereof.

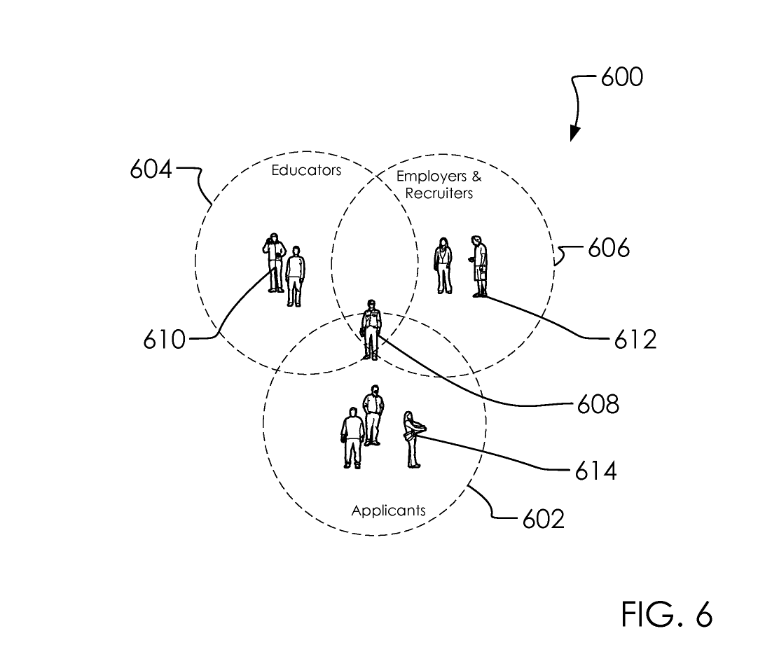

FIG. 6 illustrates user relationship diagram of a user roles Venn diagram 600.

Illustrated herein are an user roles Venn diagram 600, an applicants group 602, an educators group 604, a recruiters group 606, a complete user 608, an educator only users 610, a recruiter only users 612, an applicant only users 614.

In one embodiment, said user roles Venn diagram 600 can comprise said applicants group 602, said educators group 604, said recruiters group 606, said complete user 608, said educator only users 610, said recruiter only users 612, and said applicant only users 614.

In one embodiment, said user roles Venn diagram 600 can illustrate the roles of users within said user list table 502. In one embodiment, said user list table 502 can comprise one or more fields (summarized under said 616/) where said Applicant 502e, said Employer 502f, said Recruiter 502g and said Educator 502h represent flags related to the status of users. For simplicity, said user roles Venn diagram 600 does not have a fourth circle related to said Employer 502f and said Recruiter 502g, they have been summarized as one group here.

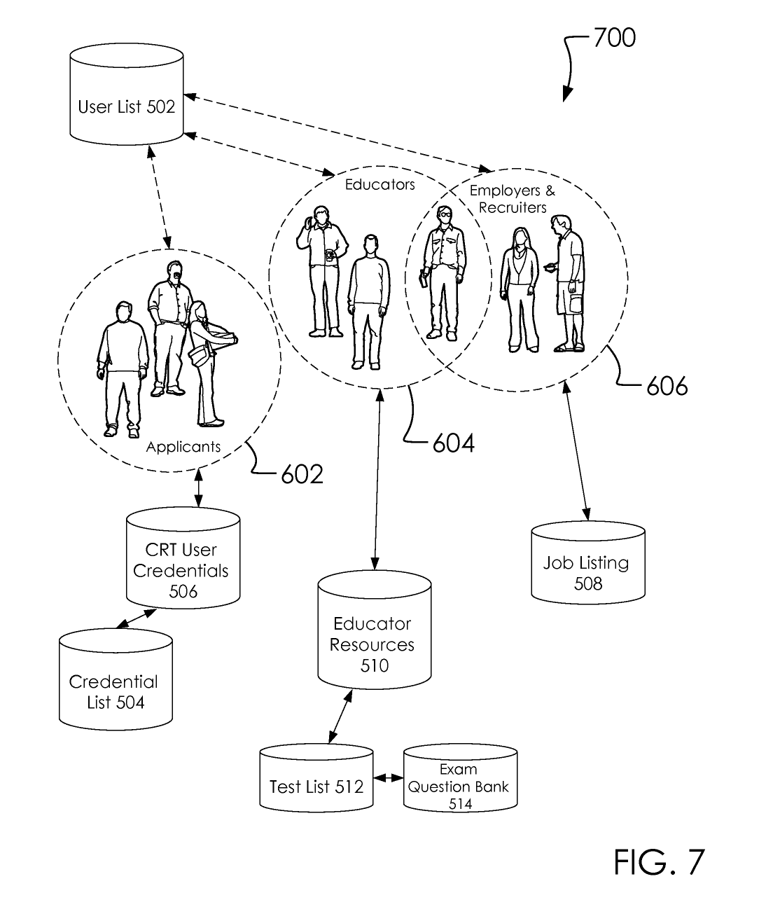

FIG. 7 illustrates diagram view of a database table relationship diagram 700.

In one embodiment, said user list table 502 can be divided up as discussed above among different user types.

In one embodiment, that portion of said user list table 502 related to said applicants group 602 can comprise applicants for jobs; wherein, this group can have their credentials managed with said CRT user credentials table 506 and said credential list table 504. In one embodiment, said credential list table 504 can comprise a list of available credentials for users of said device application 402, and said CRT user credentials table 506 can comprise a list of those credentials which each users in said user list table 502 has qualified under. Accordingly, said CRT user credentials table 506 can comprise a list of certifications, credentials or skills which are verified by said device application 402 and summarized therein.

In one embodiment, a portion of said user list table 502 can comprise educators and said device application 402 can manage their digital assets with said education resource table 510, said test list table 512, and said exam question bank table 514. In one embodiment, said education resource table 510 can comprise a list of resources associated with one or more among said educators group 604. In one embodiment, said test list table 512 can comprise a list of exams available to users of said device application 402 as described to come. In one embodiment, said test list table 512 can comprise a one or more questions for each exam and those questions can be summarized in said exam question bank table 514, as is known in the art.

In one embodiment, said recruiters group 606 can have their digital assets managed with said job listing table 508. In one embodiment, said job listing table 508 can comprise a list of open jobs, projects or similar.

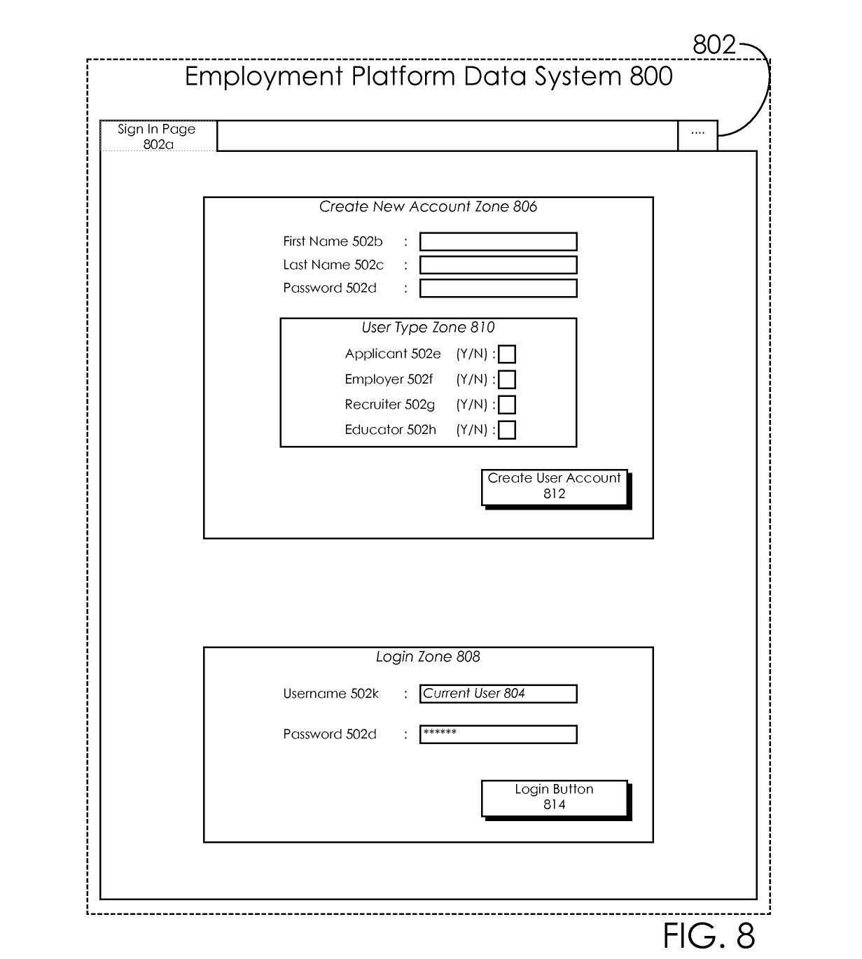

FIG. 8 illustrates a user interface view of an employment platform data system 800.

Illustrated herein are an employment platform data system 800, a tab bar 802, a sign in page tab 802a, an user credentials tab 802b, an all available credentials tab 802c, a my applications tab 802d, a learning center tab 802e, a resource creation tab 802f, a create new account zone 806, a login zone 808, an user type zone 810, a create user account button 812, and a login button 814.

In one embodiment, said employment platform data system 800 can comprise said tab bar 802. In one embodiment, said tab bar 802 can comprise said sign in page tab 802a, said user credentials tab 802b, said all available credentials tab 802c, said my applications tab 802d, said learning center tab 802e, said resource creation tab 802f. In one embodiment, said sign in page tab 802a can comprise said create new account zone 806, said login zone 808. In one embodiment, said all available credentials tab 802c can comprise said all credentials zone 1002, said related education resources zone 1004. In one embodiment, said my applications tab 802d can comprise said my applications zone 1102. In one embodiment, said learning center tab 802e can comprise said related credentials zone 1202, said URL display zone 1204, said testing zone 1206. In one embodiment, said create new account zone 806 can comprise said user type zone 810, said create user account button 812. In one embodiment, said login zone 808 can comprise said login button 814.

In one embodiment, said sign in page tab 802a can comprise a sign in page, as is known in the art.

In one embodiment, said create new account zone 806 can comprise said First Name 502b, said Last Name 502c, and said Password 502d. In one embodiment, said user type zone 810 can comprise said Applicant 502e, said Employer 502f, said Recruiter 502g and said Educator 502h.

In one embodiment, said login zone 808 can comprise said Username 502k and said Password 502d.

Said create user account button 812 and said login button 814 can be used, as is known in the art.”

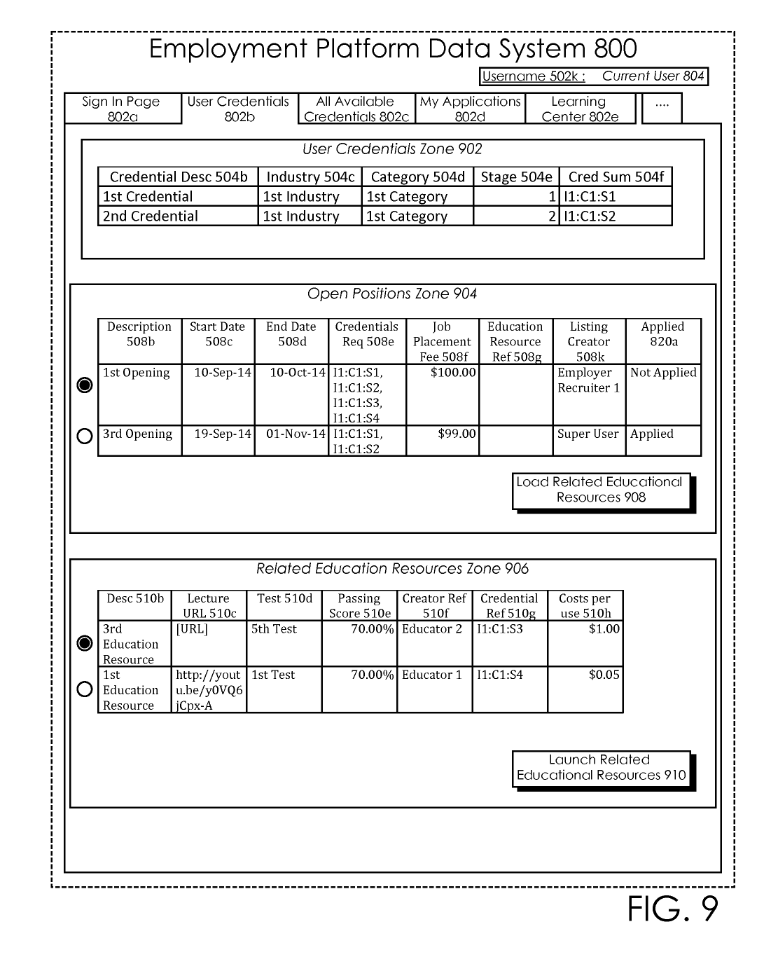

FIG. 9 illustrates a user interface view of a user credentials tab 802b.

Illustrated herein are an user credentials zone 902, an open positions zone 904, a related education resources zone 906, a load related educational resources button 908, a launch related educational resources 910, an applied field 920a.

In one embodiment, said user credentials zone 902 can comprise said user credentials zone 902, said open positions zone 904, said related education resources zone 906. In one embodiment, said open positions zone 904 can comprise said load related educational resources button 908, said applied field 920a. In one embodiment, said related education resources zone 906 can comprise said launch related educational resources 910.

In one embodiment, said user credentials zone 902 can comprise existing credentials related to said 804/(that is, the user being logged into said device application 402 at this point). In one embodiment, said user credentials zone 902 can comprise all the current credentials said 804/can use to apply for work.

In one embodiment, said open positions zone 904 can comprise open positions and/or project that might be of interest to said 804/. In one embodiment, said Description 508b can comprise two jobs where one has been applied for and the other has not. As illustrated, said 820a/can comprise a flag to show whether said 804/has applied for an opportunity in said open positions zone 904 or not.

In one embodiment, said open positions zone 904 can be populated where said Credentials Req 508e comprises one or more credentials or interests of said 804/. However, in one embodiment, said “1st Opening” comprises four credentials even though said 804/only has half of those are currently within said user credentials zone 902 of said 804/.

In one embodiment, said related education resources zone 906 can comprise a list of educational resources which can be used by said 804/to earn new credentials. For example, in one embodiment, said 804/can earn a needed credential by working on said “3rd Education Resource”. In one embodiment, said related education resources zone 906 can display a price for each resource being used in said Costs per use 510h.

In one embodiment, said Desc 510b can comprise a title; said Lecture URL 510c can comprise a link to a leaning resource; said Test 510d can comprise a name and cross reference to a test for earning the credential (as discussed to come); said Passing Score 510e can comprise a minimum passing score for earning a credential; said Creator Ref 510f can comprise a name of another user having created a resource; In one embodiment, said Credential Ref 510g can comprise a name of a credential which can be earned through the resource; and said Costs per use 510h can comprise a price for using the resource.

In one embodiment, said Costs per use 510h can be paid by a recruiter, an employer and/or a recruit.

In one embodiment, said open positions zone 904 can select one amount said open positions zone 904 click said load related educational resources button 908; thereafter, select one among said related education resources zone 906 and click said launch related educational resources 910 to load such a resource. In one embodiment, that resource can be loaded in said learning center tab 802e, to be discussed below.

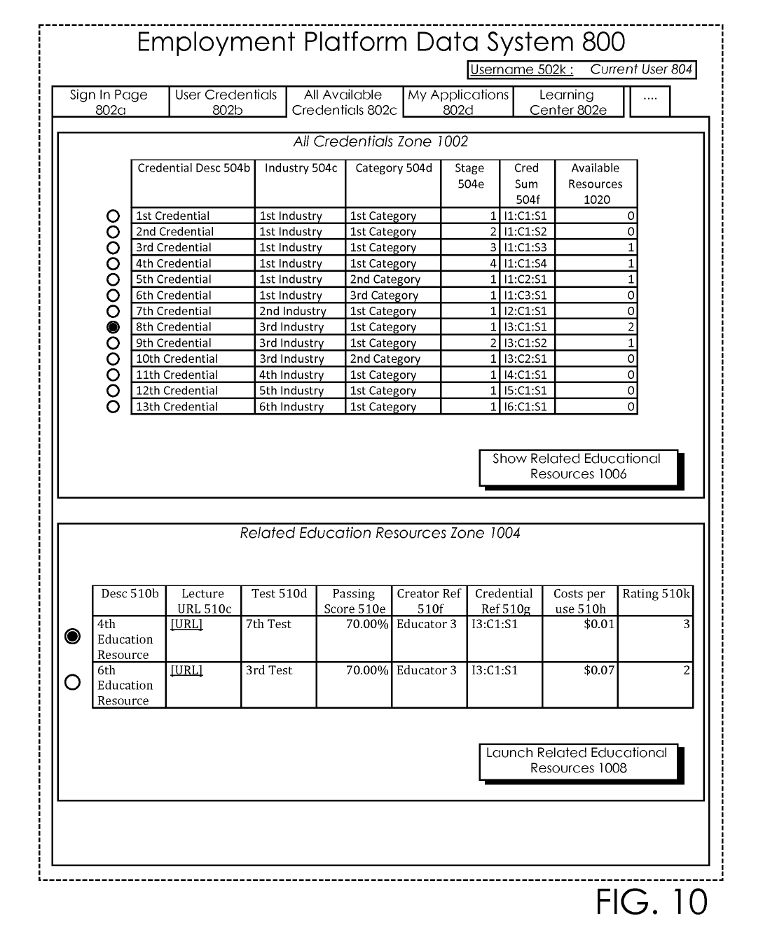

FIG. 10 illustrates a user interface view of an all available credentials tab 802c.

Illustrated herein are an all credentials zone 1002, a related education resources zone 1004, a show related educational resources button 1006, a launch related educational resources 1008.

In one embodiment, said all credentials zone 1002 can comprise said show related educational resources button 1006. In one embodiment, said related education resources zone 1004 can comprise said launch related educational resources 1008.

In one embodiment, selecting a record in said all credentials zone 1002 can cause said related education resources zone 1004 to load, as is known in the art.

In one embodiment, said all credentials zone 1002 can comprise a one or more records corresponding to available categories, industries and credentials, as described herein.

As illustrated, an “8th Credential” can be earned by working on one of two offered educational resources, as shown in said related education resources zone 1004.

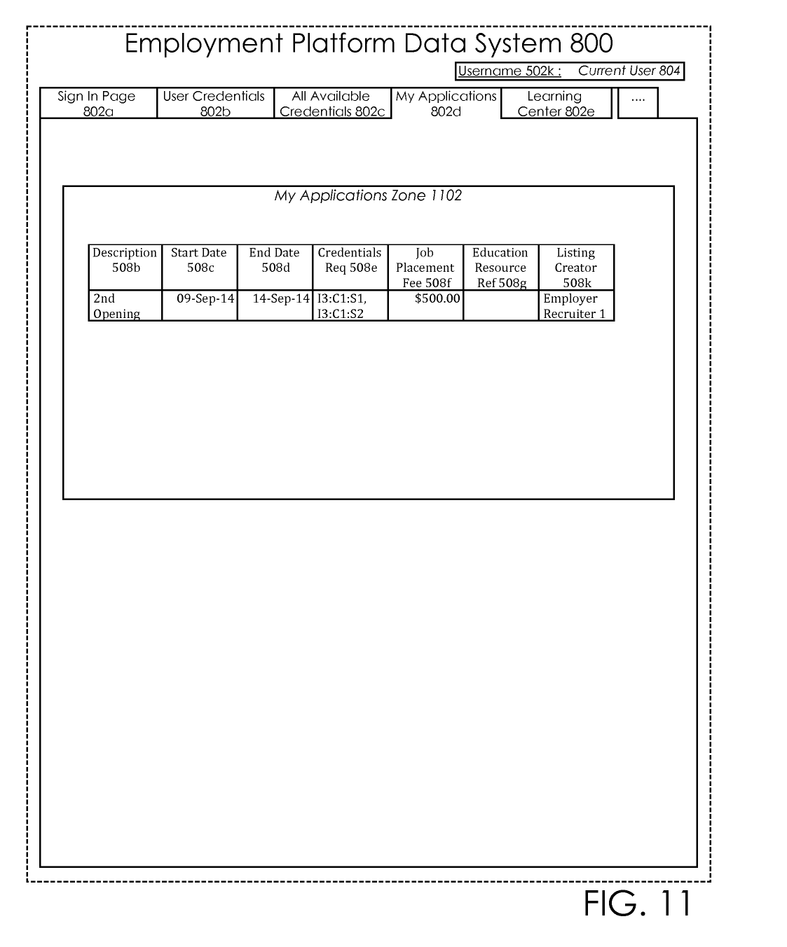

FIG. 11 illustrates a user interface view of a my applications tab 802d.

In one embodiment, said my applications zone 1102 can comprise a list of jobs which said 804/has applied for previously.

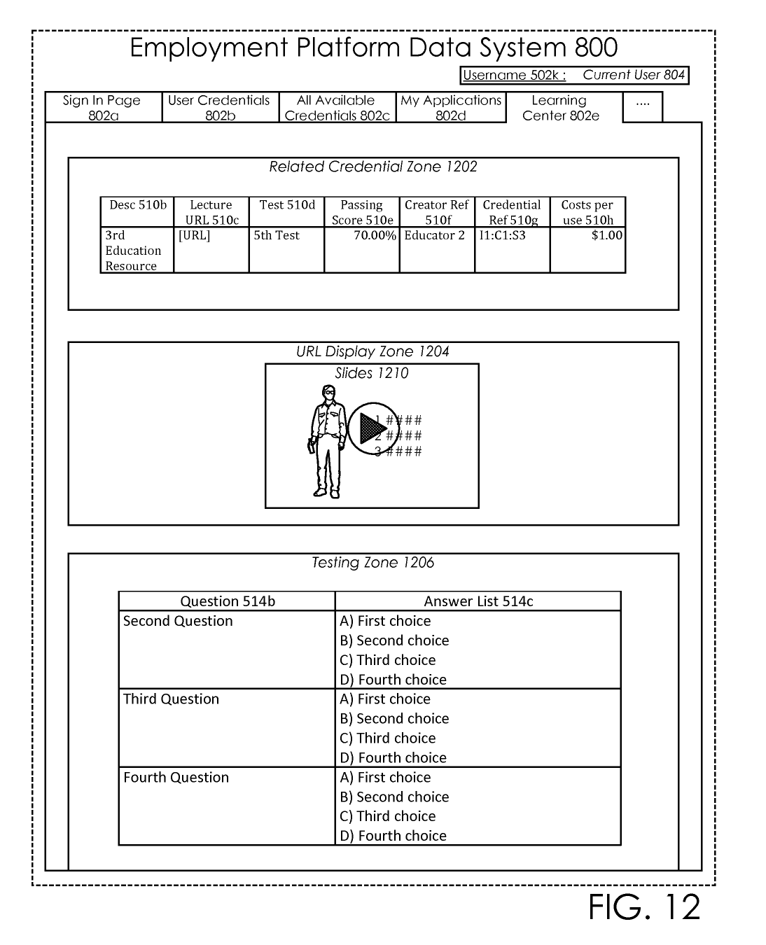

FIG. 12 illustrates a user interface view of a learning center tab 802e.

Illustrated herein are a related credentials zone 1202, an URL display zone 1204, a testing zone 1206, a slides 1210.

In one embodiment, said URL display zone 1204 can comprise said slides 1210.

In one embodiment, said learning center tab 802e can be loaded when said 804/selects a resource for learning and testing.

In one embodiment, said related credentials zone 1202 can comprise a description of the resource being worked upon.

In one embodiment, said URL display zone 1204 can display a resource related to said Lecture URL 510c for the learning and education of said 804/.

In one embodiment, said testing zone 1206 can comprise an examination area for testing the competence of said 804/.”

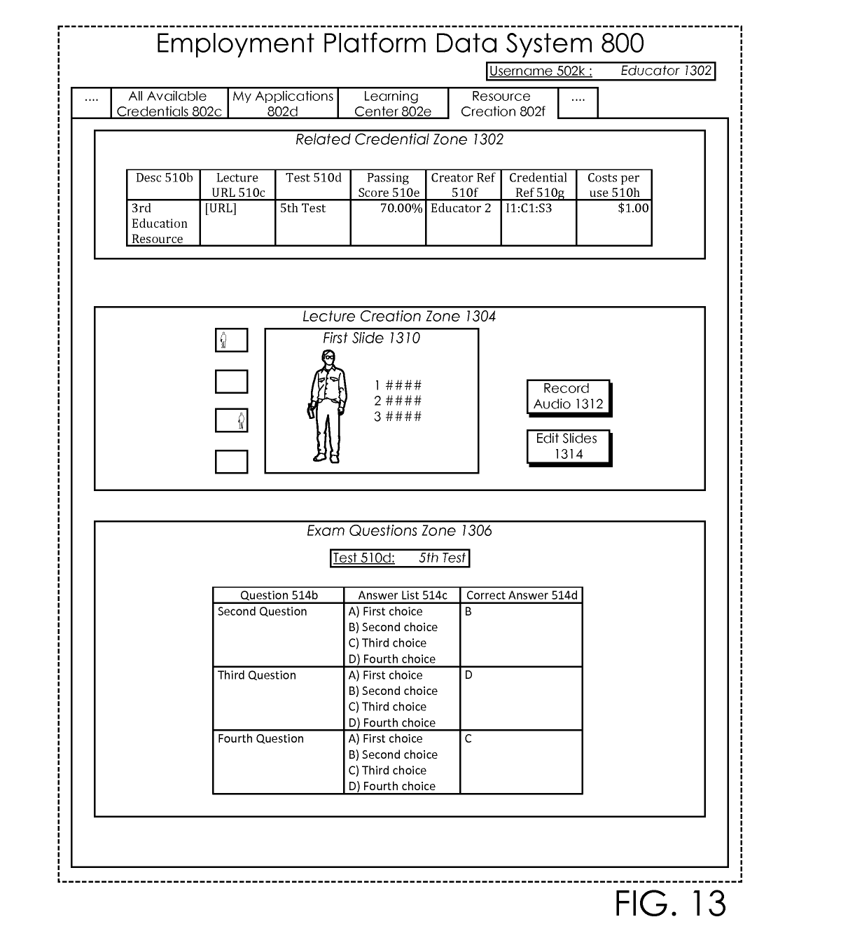

FIG. 13 illustrates a user interface view of a resource creation tab 802f.

Illustrated herein are a related credential zone 1302, a lecture creation zone 1304, an exam questions zone 1306, a firs slide 1310, a record audio button 1312, and an edit slide button 1314.

Note that on this display is logged into by said related credential zone 1302 who is credentialed to create said “5th Test” and said “3rd Education Resource” as described herein.

In one embodiment, said related credential zone 1302 can comprise a description of a resource being worked upon.

In one embodiment, said lecture creation zone 1304 can comprise said Test 510d for describing the current resource; said lecture creation zone 1304 can be used to edit a lecture corresponding to said Lecture URL 510c. In one embodiment, said record audio button 1312 and said edit slide button 1314, work as is known in the art.

In one embodiment, said exam questions zone 1306 can be used to editing an exam to be used for testing said 804/.”

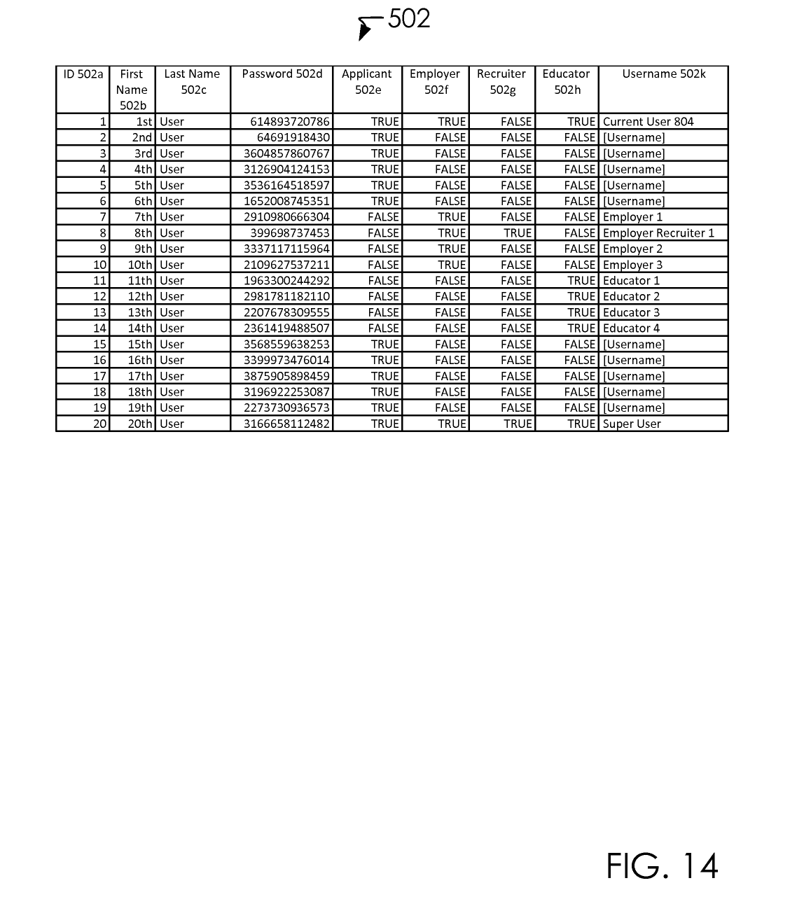

FIG. 14 illustrates a database table view of said user list table 502.

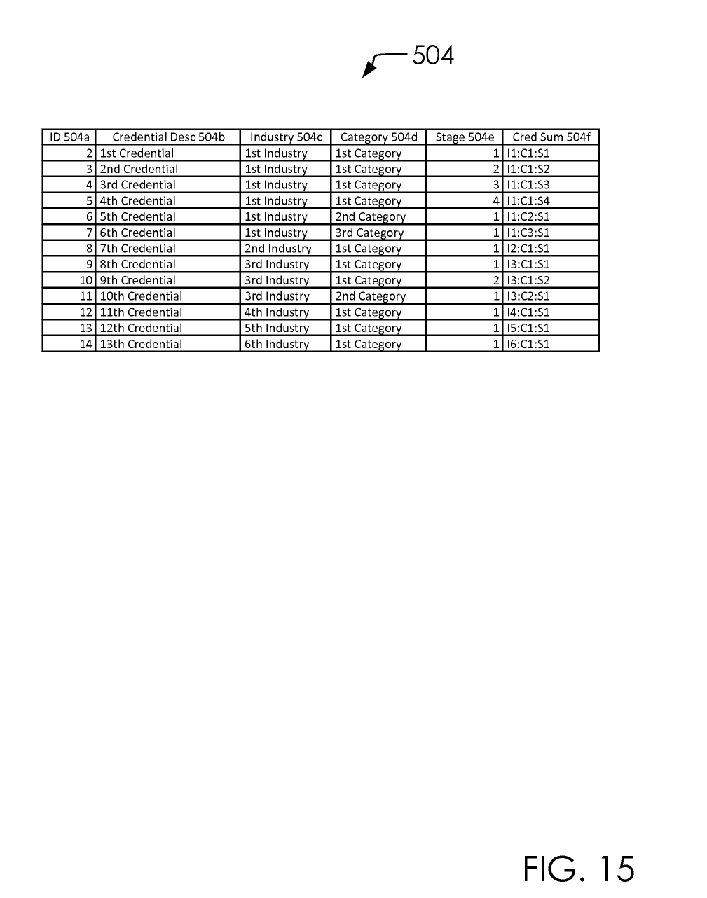

FIG. 15 illustrates a database table view of said credential list table 504.

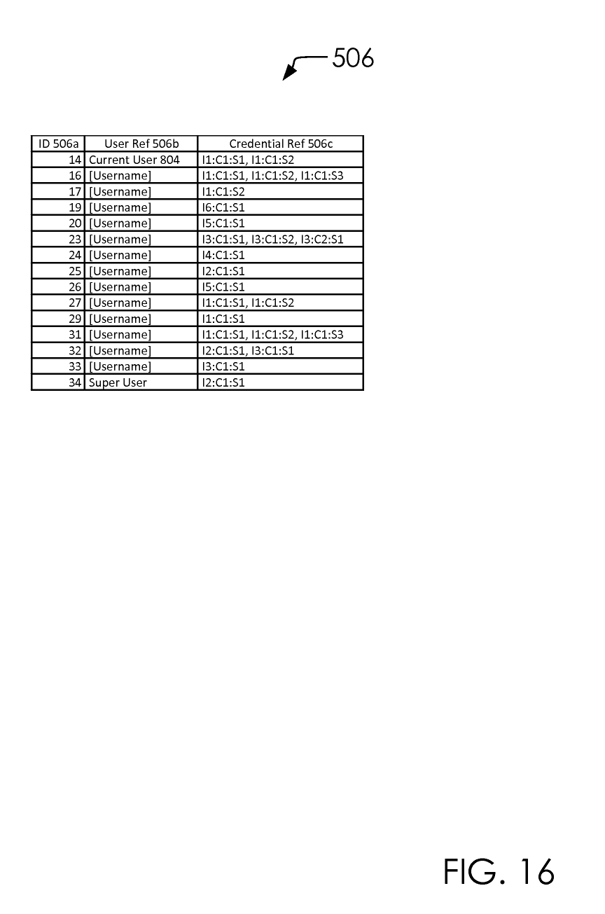

FIG. 16 illustrates a database table view of said CRT user credentials table 506.

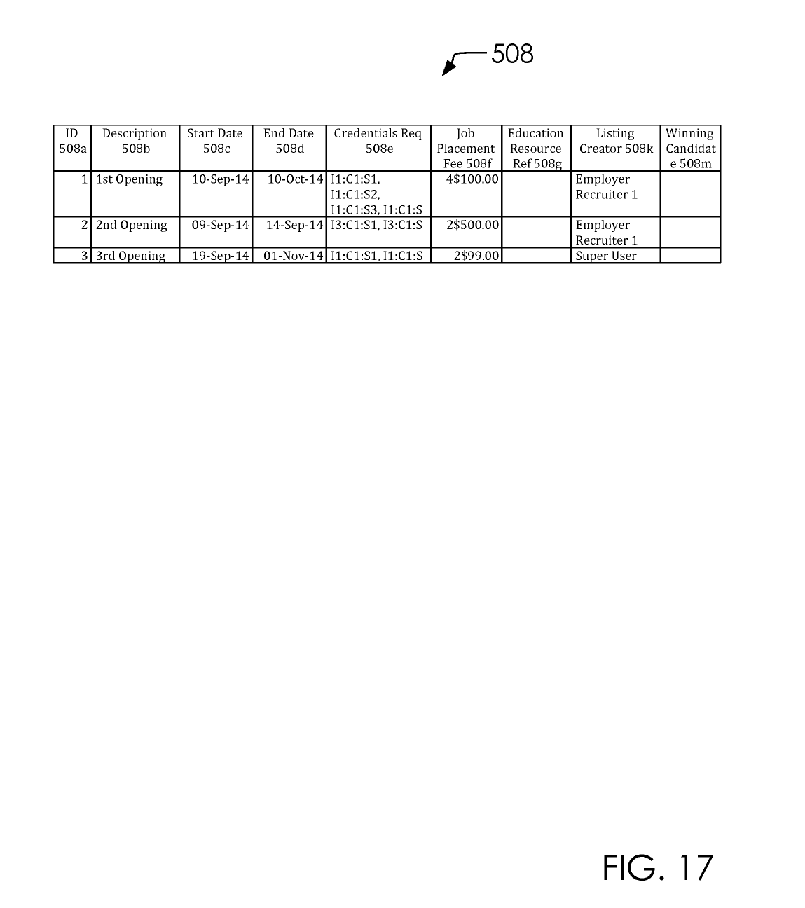

FIG. 17 illustrates a database table view of said job listing table 508.

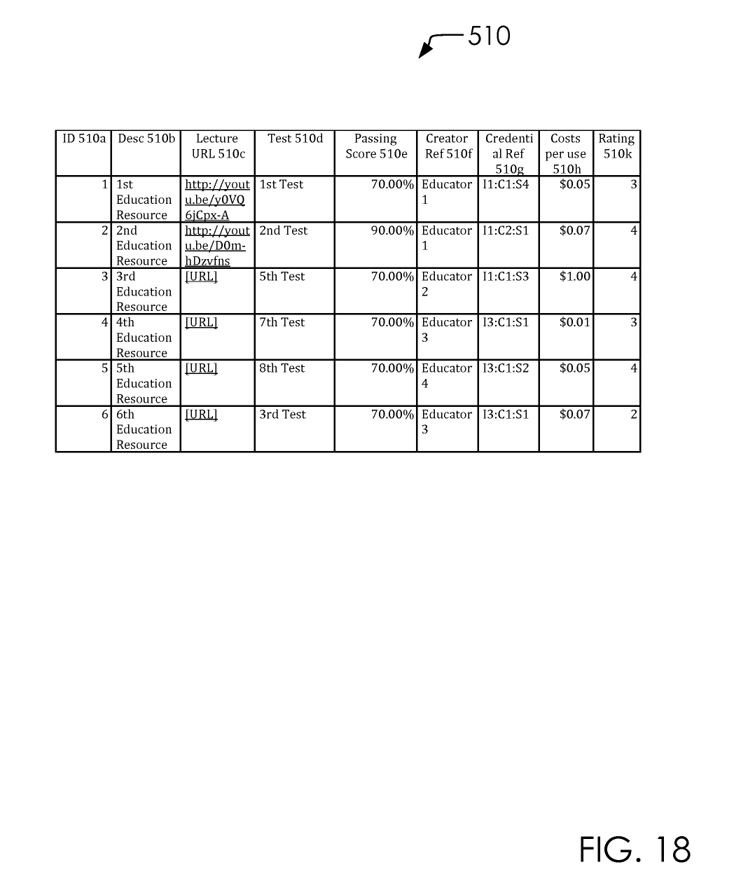

FIG. 18 illustrates a database table view of said education resource table 510.

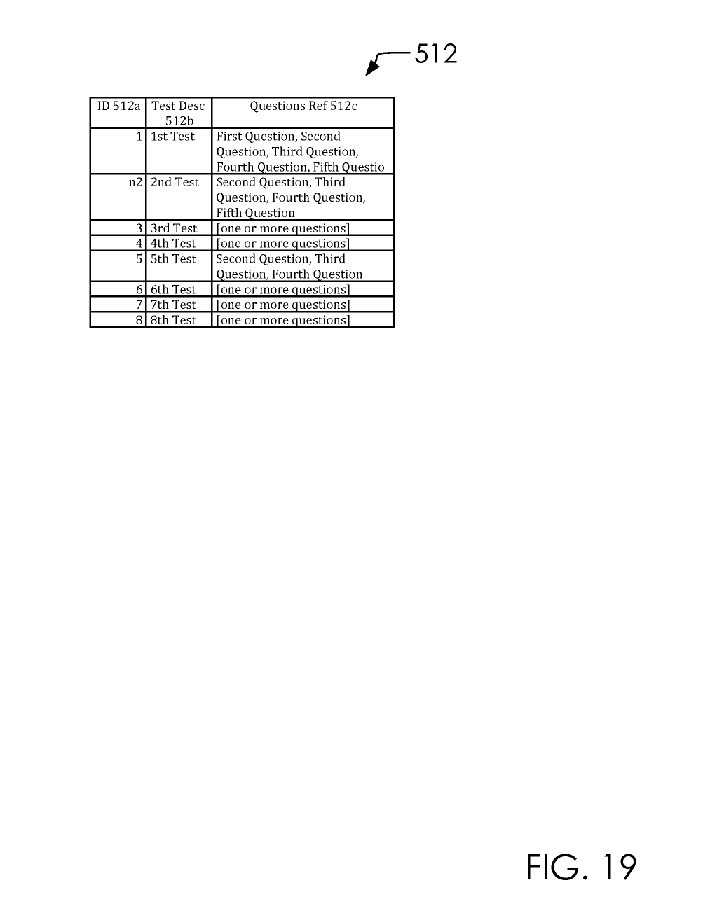

FIG. 19 illustrates a database table view of said test list table 512.

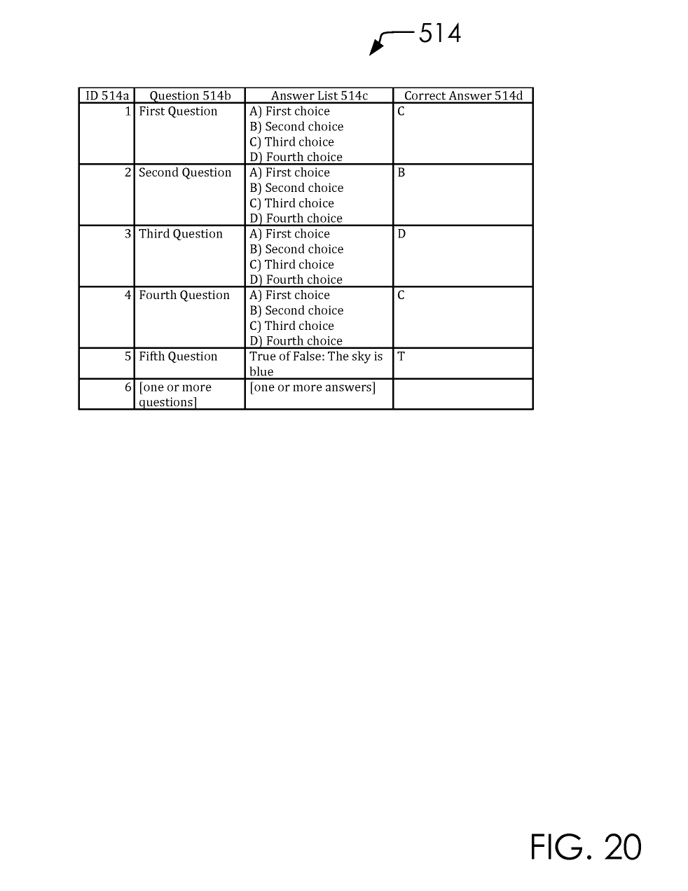

FIG. 20 illustrates a database table view of said exam question bank table 514.

[00103.1] In one embodiment, said device application 402 can: catalog users in a user list table as being an applicant, an educator, and/or a recruiter; correlate one or more open opportunities with a one or more credentials; correlate said one or more credentials with a one or more educational resource; said one or more educational resources each comprising a test; a portion of said users comprising applicants qualify under a portion of said one or more credentials and apply for a portion of said one or more open opportunities correlated with said one or more credentials; said portion of said users comprising said educators selectively create said one or more educational resource to support the credentialing process for said applicants and said recruiters; and said recruiters set up said one or more opportunities and select a portion of said one or more educational resources for said one or more opportunities.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An apparatus, comprising:
at least one memory including computer program code; and
at least one processor,
wherein the at least one memory and the computer program code are configured to, with the at least one processor, cause the apparatus at least to:
catalog users in a user list table as being an applicant, an educator, and/or a recruiter;
correlate one or more open opportunities with a one or more credentials;
correlate said one or more credentials with a one or more educational resource;
said one or more educational resources each comprising a test;
a portion of said users comprising applicants qualify under a portion of said one or more credentials and apply for a portion of said one or more open opportunities correlated with said one or more credentials;
said portion of said users comprising said educators selectively create said one or more educational resource to support the credentialing process for said applicants and said recruiters; and
said recruiters set up said one or more opportunities and select a portion of said one or more educational resources for said one or more opportunities.

2. A method for employment verification and recruiting, the method comprising:
cataloging users in a user list table as being an applicant, an educator, and/or a recruiter,
correlating one or more open opportunities with a one or more credentials, and
correlating said one or more credentials with a one or more educational resource; wherein,
said one or more educational resources each comprising a test;
a portion of said users comprising applicants qualify under a portion of said one or more credentials and apply for a portion of said one or more open opportunities correlated with said one or more credentials;
said portion of said users comprising said educators selectively create said one or more educational resource to support the credentialing process for said applicants and said recruiters; and
said recruiters set up said one or more opportunities and select a portion of said one or more educational resources for said one or more opportunities.

3. A computer program product embodied on a non-transitory computer readable storage medium, the computer program product being encoded with instructions to control a processor to perform a process, the process comprising:
cataloging users in a user list table as being an applicant, an educator, and/or a recruiter,
correlating one or more open opportunities with a one or more credentials, and
correlating said one or more credentials with a one or more educational resource; wherein,
said one or more educational resources each comprising a test;
a portion of said users comprising applicants qualify under a portion of said one or more credentials and apply for a portion of said one or more open opportunities correlated with said one or more credentials;
said portion of said users comprising said educators selectively create said one or more educational resource to support the credentialing process for said applicants and said recruiters; and
said recruiters set up said one or more opportunities and select a portion of said one or more educational resources for said one or more opportunities.
